(19) United States
(12) Patent Application Publication
(10) Pub. No.: US 2014/0176451 A1
(43) Pub. Date: Jun. 26, 2014

(54) METHOD FOR ADAPTIVE SCAN RATE FOR AN ELECTRONIC DEVICE

(71) Applicant: BARNESANDNOBLE.COM LLC, New York, NY (US)

(72) Inventor: Songan Andy Chang, San Jose, CA (US)

(73) Assignee: barnesandnoble.com llc, New York, NY (US)

(21) Appl. No.: 13/725,274

(22) Filed: Dec. 21, 2012

(51) Int. Cl. G06F 1/32

(52) U.S. Cl. CPC G06F 1/3262
USPC 345/173

(57) ABSTRACT

Techniques are disclosed for setting a scan rate for an electronic device based on interaction with the user and/or application type.

### RELATED APPLICATION

This application is related to U.S. application Ser. No. xx/xxx,xxx (Attorney Docket BN01.757US) filed Dec. 21, 2012 and titled “System and Apparatus for Adaptive Setting of Scan Rate” which is herein incorporated by reference in its entirety.

### FIELD OF THE DISCLOSURE

This disclosure relates to a method for adaptive scan rate for an electronic device.

### BACKGROUND

Presently, electronic devices are present in various form factors, such as, tablets, cell phones, laptops, eBook readers, etc. Presently, various challenges exist for efficiently managing and maximizing power consumption of electronic devices. For example, present techniques include a sleep mode for temporarily disabling the device based at least in part on lack of activity during a predetermined duration of time. A need exists for managing efficient power consumption of the electronic device without interrupting the use of the device.

### BRIEF DESCRIPTION OF THE DRAWINGS

Subject matter is particularly pointed out and distinctly claimed in the concluding portion of the specification. The claimed subject matter, however, both as to organization and method of operation, together with features and advantages thereof, may best be understood by reference to the following detailed description when read with the accompanying drawings in which:

FIG. 1 is a method configured in accordance with one embodiment of the present invention;

FIG. 2 is a system configured in accordance with one embodiment of the present invention; and

FIG. 3 illustrates a block diagram of a communication system configured in accordance with an embodiment of the present invention.

### DETAILED DESCRIPTION

The proposed solution teaches a method and system for setting a scan rate for an electronic device. In some embodiments, the subject matter herein may utilize or incorporate subject matter in the previously incorporated patent application titled, “System and Apparatus for Adaptive Setting of Scan Rate” (Attorney Docket BN01.757US).

As previously discussed, various challenges exist for efficiently managing and maximizing power consumption of electronic devices. For example, present techniques include a sleep mode for temporarily disabling the device based at least in part on lack of activity during a predetermined duration of time. A need exists for managing efficient power consumption of the electronic device without interrupting the use of the device.

Typically, an electronic device utilizes display hardware to draw or update the data, video, or text on a display. The frequency of this operation is referred to as a scan rate or refresh rate. For example, the scan rate is typically listed in a unit of frequency known as Hertz, which is defined as the number of cycles per second of a periodic phenomenon. In the example of display hardware, the periodic phenomenon is the frequency of the display hardware updating or redrawing the data, video, or text on the display.

One embodiment of the present invention facilitates an adaptive scan rate of the display hardware for an electronic device. In one aspect, the adaptive scan rate is based on setting a scan rate based at least in part on an application type. For instance, gaming applications may use a higher scan rate than word processing applications, so as to provide a better user experience. In another aspect, the adaptive scan rate is based on setting a scan rate based at least in part on other factors, such as frequency of a user touching the display. In yet another aspect, the adaptive scan rate is based on setting a scan rate based at least in part on the speed of the user touching the display.

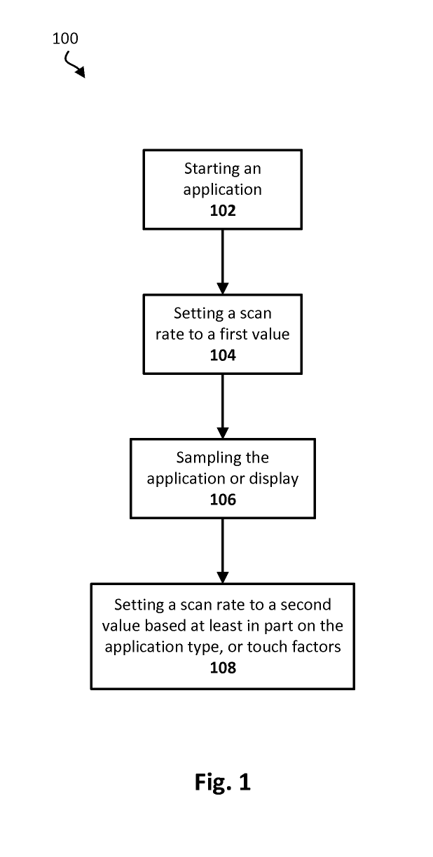

FIG. 1 illustrates a method configured in accordance with one embodiment of the present invention. In a first step, depicted as block 102, an application is started on any electronic device, such as, a cell phone, eBook reader, laptop, tablet, etc. Alternatively, the electronic device initiates the starting of an application that is stored in a public or private cloud. Consequently, a scan rate is set to a first value, depicted as block 104. In one embodiment, the first value for the scan rate is selected at a maximum value for that particular application or electronic device. Alternatively, it may be set to a value at a predetermined threshold below the maximum value. In some such embodiments, the predetermined threshold may be determined, for example, based on empirical data, theoretical data, and/or established user preferences that are indicative of a scan rate that does not create perception or performance issues or is otherwise suitable.

Subsequently, as depicted in block 106, a sampling is performed on the application or display to determine the interaction with the user and whether an update to the scan rate is needed. For example, if the sampling indicates minimal interaction with the user, a lower scan rate could be used. On the other hand, if the sampling indicates greater interaction with the user than anticipated, a higher scan rate can be used (assuming a higher scan rate is available). Consequently, at block 108, the scan rate is set to a second value based on the previous result of the sampling from block 106.

With respect to some embodiments, the following scenarios and applications are listed for descriptive purposes to facilitate the understanding of the techniques provided herein. For one example, the first scan rate may be set to 60 Hertz (Hz). Typically, this scan rate is acceptable for a reading application. However, upon sampling of an application by an expert game user for a cooking game that requires consistent touching of the screen, the scan rate may be increased to, for example, 120 Hz or other suitably higher scan rate to accommodate the need for quick updates. Alternatively, the scan rate could be based on the speed of the user touching the screen.

Alternatively, a particular application may be terminated and require another update to the scan rate based on different interactions for users reading a book. For example, a child may require a different scan rate than an adult due to more interactions with the screen or quicker page turns. For example, a user profile may be used to set different scan rates for different applications. Thus, depending on the given user (e.g., based on log-in credentials or active user account), the scan rate can be set accordingly.

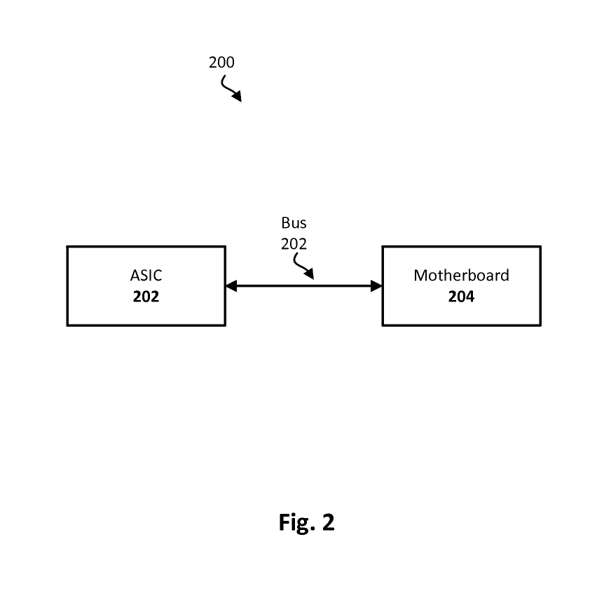

FIG. 2 is a system configured in accordance with one embodiment of the present invention. In one such example embodiment, the system includes a combination of hardware and software implementations to facilitate the setting of the scan rate depicted earlier for an application.

In one specific example embodiment, an ASIC (Application Specific Integrated Circuit) 204 communicates with a host motherboard 206 via a communication bus 202. In one embodiment, the bus may be an I²C bus that conforms to a two wire interface for an inter-integrated circuit. However, any suitable communication bus technology can be used, as will be appreciated in light of this disclosure.

In one example embodiment, software may reside on either the ASIC 204 and/or the motherboard 206 to control the scan rate setting and sampling as previously described herein. For example, the ASIC 204 may contain firmware to control the scan rate. Alternatively, the motherboard 206 may utilize software at the framework layer that issues commands to the firmware stored on the ASIC 204 via the bus 202. In another embodiment, the software on the motherboard 206 may utilize APIs (Application Programming Interfaces) at the kernel level to facilitate the scan rate setting and analysis.

The ASIC 204, which may also be a microcontroller or other purpose-built semiconductor, can be implemented, for example, as a touch screen controller, in accordance with some embodiments. An example suitable touch screen controller is the CYP658756 by Cypress Semiconductor. The techniques described herein can be programmed or otherwise configured into the ASIC 204, which can in turn receive various control signals from a processor of the motherboard 206 to further give effect to the techniques provided herein, in accordance with some embodiments.

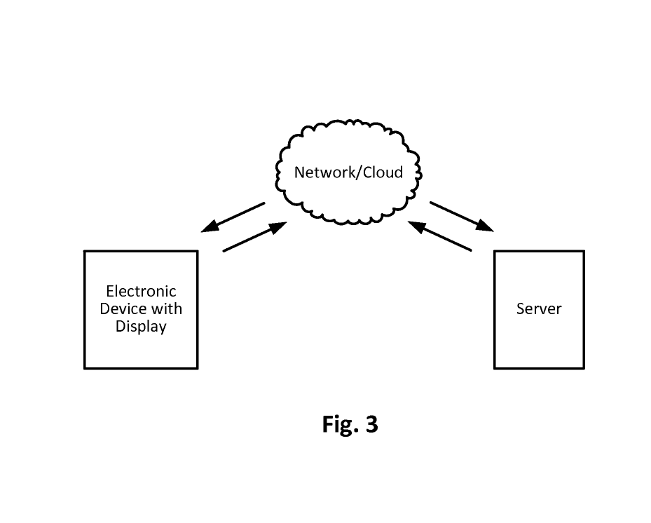

FIG. 3 illustrates a block diagram of a communication system configured in accordance with an embodiment of the present invention. As can be seen, the system generally includes an electronic device with a display that is capable of communicating with a server via a network/cloud. In this example embodiment, the electronic device may be, for example, an eBook reader, a mobile cell phone, a laptop, a tablet, desktop, game console, set-top box and television, or any other computing device configured with or otherwise operable with a display. The network/cloud may be a public and/or private network, such as a private local area network operatively coupled to a wide area network such as the Internet. In this example embodiment, the server may be programmed or otherwise configured to receive content requests from a user via the electronic device and to respond to those requests by providing the user with requested or otherwise recommended content (e.g., applications). Is some such embodiments, the server is configured to remotely provision an adaptive scan rate as provided herein to the electronic device (e.g., via JavaScript or other browser based technology). In other embodiments, portions of the content selecting methodology are executed on the server and other portions of the methodology are executed on the device. Numerous server-side/client-side execution schemes can be implemented to facilitate a content selecting mode in accordance with an embodiment, as will be apparent in light of this disclosure.

Numerous variations will be apparent in light of this disclosure. For instance, one example embodiment provides a method for setting a scan rate. The method includes setting a first value for a scan rate, sampling an application based at least in part on user interaction with the application, and setting a second value for the scan rate based at least in part on the sampling of the application. In some cases, the scan rate is for a display of a touch screen device. In some cases, setting the first value includes setting a maximum scan rate for the particular application. In some cases, setting the first value includes setting a maximum scan rate for the particular electronic device running the application. In some cases, the sampling is based on a number of touches by the user. In some cases, the setting of the second value for the scan rate is performed for initiation of a subsequent application. In some cases, the setting of the first and second values is based on a predetermined setting for a particular user profile. Another embodiment provides a computer readable medium encoded with instructions that, when executed by one or more processors, cause a process to be carried out, the process including the scan rate setting methodology as variously described in this paragraph.

Another embodiment of the present invention provides a method for setting a scan rate. In this example case, the method includes initiating an application on an electronic device in response to a user request, setting a first value for a scan rate, sampling the application based at least in part on user interaction with the application, and setting a second value for the scan rate based at least in part on the sampling of the application. In some cases, setting the first value includes setting a maximum scan rate for the application. In some cases, setting the first value includes setting a maximum scan rate for the electronic device running the application. In some cases, the sampling is based on a speed of touches by the user. In some cases, the setting of the second value for the scan rate is performed for initiation of a subsequent application. In some cases, the setting of the first and second values is based on a predetermined setting for a particular user profile. In some cases, the sampling is based on a number of touches by the user. In some cases, the application is stored remotely in a cloud repository and is served to the electronic device in response to the user request. In some cases, the application is stored locally on the electronic device and is launched in response to the user request. Another embodiment provides a computer readable medium encoded with instructions that, when executed by one or more processors, cause a process to be carried out, the process including the scan rate setting methodology as variously described in this paragraph.

Another embodiment of the present invention provides an electronic system including a display, and a controller. The controller is configured to set a first value for a scan rate and to sample an application based at least in part on user interaction with the application. The controller is further configured to set a second value for the scan rate based at least in part on the sampling of the application. In some cases, the system is one of an eReader device or a tablet computing device. In some cases, the display and controller are implemented in an electronic computing device, and the system further comprises a server for providing access to the application in response to user requests from the electronic computing device. In some cases, the display is a touch screen display and the controller is a touch screen controller.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for setting a scan rate, comprising:
setting a first value for a scan rate;
sampling an application based at least in part on user interaction with the application; and
setting a second value for the scan rate based at least in part on the sampling of the application.

2. The method of claim 1 wherein the scan rate is for a display of a touch screen device.

3. The method of claim 1 wherein setting the first value includes setting a maximum scan rate for the particular application.

4. The method of claim 1 wherein setting the first value includes setting a maximum scan rate for the particular electronic device running the application.

5. The method of claim 1 wherein the sampling is based on a number of touches by the user.

6. The method of claim 1 wherein the setting of the second value for the scan rate is performed for initiation of a subsequent application.

7. The method of claim 1 wherein the setting of the first and second values is based on a predetermined setting for a particular user profile.

8. A method for setting a scan rate comprising:
initiating an application on an electronic device in response to a user request;
setting a first value for a scan rate;
sampling the application based at least in part on user interaction with the application; and
setting a second value for the scan rate based at least in part on the sampling of the application.

9. The method of claim 8 wherein setting the first value includes setting a maximum scan rate for the application.

10. The method of claim 8 wherein setting the first value includes setting a maximum scan rate for the electronic device running the application.

11. The method of claim 8 wherein the sampling is based on a speed of touches by the user.

12. The method of claim 8 wherein the setting of the second value for the scan rate is performed for initiation of a subsequent application.

13. The method of claim 8 wherein the setting of the first and second values is based on a predetermined setting for a particular user profile.

14. The method of claim 8 wherein the sampling is based on a number of touches by the user.

15. The method of claim 8 wherein the application is stored remotely in a cloud repository and is served to the electronic device in response to the user request.

16. The method of claim 8 wherein the application is stored locally on the electronic device and is launched in response to the user request.

17. An electronic system, comprising:
a display; and
a controller configured to set a first value for a scan rate, and to sample an application based at least in part on user interaction with the application, and to set a second value for the scan rate based at least in part on the sampling of the application.

18. The system of claim 17 wherein the system is one of an eReader device or a tablet computing device.

19. The system of claim 17 wherein the display and controller are implemented in an electronic computing device, and the system further comprises a server for providing access to the application in response to user requests from the electronic computing device.

20. The system of claim 17 wherein the display is a touch screen display and the controller is a touch screen controller.
